(19) United States
(12) Patent Application Publication
(10) Pub. No.: US 2006/0056851 A1
(43) Pub. Date: Mar. 16, 2006

(54) Free-space optical communication apparatus

(76) Inventor: Koichi Takahashi, Tokyo (JP)

Correspondence Address: KENYON & KENYON LLP, ONE BROADWAY, NEW YORK, NY, 10004, US

(21) Appl. No.: 11/191,051

(22) Filed: Jul. 28, 2005

(30) Foreign Application Priority Data
Aug. 2, 2004 (JP) P 2004-225921

(51) Int. Cl. H04B 10/00

(52) U.S. Cl. 398/118

(57) ABSTRACT

A free-space optical communication apparatus of this invention is provided with an optical antenna portion and an input/output port portion on a tracking platform. A transceiving module, which includes a signal receiving portion, a laser diode and similar, is provided separately therefrom. The input/output port portion and the transceiving module are optically connected by an optical fiber.

### BACKGROUND OF THE INVENTION

Priority is claimed on Japanese Patent Application No. 2004-225921, filed on Aug. 2, 2004, the entire contents of which are incorporated herein by reference.

1. Field of the Invention

This invention relates to a free-space optical communication apparatus. The free-space optical communication apparatus has optical tracking mechanisms mounted on each terminal to perform optical communication while tracking the positions of terminals, in which the optical communication is carries out, for example, between automobiles on the ground, between aircraft in motion in the sky and satellites, or in mobile communication between these and terminals on the ground.

2. Description of the Related Art

A conventional free-space optical communication apparatus includes a light source which generates the communication light and tracking light; a light-emission portion which emits these lights; a light-receiving portion which receives communication light and tracking light from the other terminal of the communication; position detection means for detecting the position of received tracking light; and a tracking platform or similar which controls the positions of the light-emission portion and light-receiving portion according to detection output from the position detection means. The light-emission portion and light-receiving portion ordinarily share an afocal optical system which converts the beam diameters of emitted light and received light. The optical axis of the afocal optical system undergoes tracking operation to align with the direction of the received tracking light as a result of movement of the tracking platform, so that two-way communication is secured.

For example, an optical transmission apparatus which performs optical transmission in free space is described in FIG. 2 and FIG. 4 of Japanese Unexamined Patent Application, First Publication, No. H11-261492. In this optical transmission apparatus, a core device consisting of an optical beam splitter is positioned on the image side of a telescope, which is an afocal optical system. The core device, light-emission device, light-receiving device, and an auxiliary device are held integrally as an optical apparatus.

### SUMMARY OF THE INVENTION

A free-space optical communication apparatus of this invention, which performs bidirectional optical communication while tracking the other terminal through free space, has at least one light source which emits light to the exterior of the apparatus; an optical antenna portion having a emission/reception light optical system which emits light from the one or more light sources and receives light from outside the apparatus, and a direction-shift detector which divides the tracking light used in tracking the other terminal from the light received by the emission/reception light optical system to detect information on direction shifts from the tracking light; a tracking platform which supports the optical antenna portion while enabling tracking movement according to the detection output from the direction-shift detector; a communication light detection portion which receives the portion of communication light modulated by information signals among the light received; a separate unit which includes at least one of the at least one light source and the communication light detection portion and is provided separately from a moveable portion of the tracking platform; a tracking unit which includes the optical antenna portion and is provided integrally with the moveable portion of the tracking platform; and an optical fiber which connects the separate unit and the tracking unit.

### BRIEF DESCRIPTION OF THE DRAWINGS

FIG. 1 is a block diagram showing in summary the configuration of a free-space optical communication apparatus according to a first embodiment of the invention;

FIG. 2 is a block diagram showing in summary the configuration of a free-space optical communication apparatus according to a second embodiment of the invention;

FIG. 3 is a block diagram showing in summary the configuration of a free-space optical communication apparatus according to a third embodiment of the invention;

FIG. 4 is a block diagram showing in summary the configuration of a free-space optical communication apparatus according to a fourth embodiment of the invention; and,

FIG. 5 is an optical path diagram, in a cross-section containing an optical axis, showing the configuration of a modified example of the first through fourth embodiments.

### DESCRIPTION OF THE PREFERRED EMBODIMENTS

Below, embodiments of the invention will be explained referring to the attached drawings. In all the drawings, the same symbols are assigned to the same or similar members even when the embodiments are different, and redundant explanations are omitted.

### First Embodiment

Below, a first embodiment of a free-space optical communication apparatus of this invention will be explained.

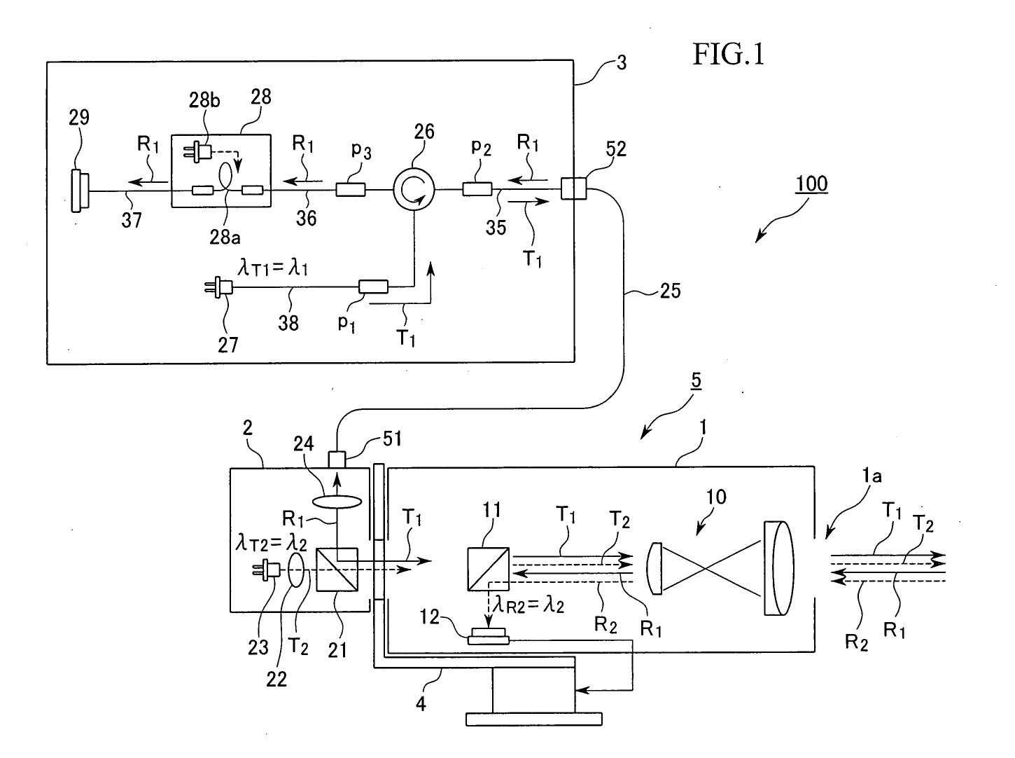

FIG. 1 is a block diagram explaining in summary the configuration of a free-space optical communication apparatus of the first embodiment of the invention.

As shown in FIG. 1, the free-space optical communication apparatus 100 of this embodiment, emits communication light T₁ modulated by information signals and tracking light T₂ used in tracking the other terminal to the communication, and receives communication light R₁ from the other terminal modulated by information signals and tracking light R₂ for tracking the other terminal to the communication. By means of this configuration, the free-space optical communication apparatus 100 can track the received tracking light R₂ and perform bidirectional communication using the communication light T₁, R₁, in a configuration which is particularly suitable for communication between mobile bodies.

Below, the wavelengths of the communication light T₁, R₁ and of the tracking light T₂, R₂ are represented by λ_{T1}, λ_{R1}, λ_{T2}, λ_{R2} respectively. These wavelengths can be set appropriately according to communication standards, communication noise, the sensitivity of receiving elements and similar; but it is desirable that different wavelengths be used for λ_{T1}, λ_{R1} and for λ_{T2}, λ_{R2}, so as to enable separation of the wavelengths of the communication light and tracking light.

For example, it is preferable that the wavelengths of the communication light T₁, R₁ and of the tracking light T₂, R₂ be set in the ranges indicated by the following conditional equations (1) and (2).
0.01 μm<|λ_{T1}−λ_{T2}|<1.2 μm (1)
0.01 μm<|λ_{R1}−λ_{R2}|<1.2 μm (2)

In this embodiment, λ_{T1}=λ_{R1}=λ₁=1550 nm, and λ_{T2}=λ_{R2}=λ₂=780 nm.

The reason for choosing a comparatively long wavelength for the communication light is to be able to reduce communication noise which depends heavily on atmospheric fluctuations. The reason for choosing a comparatively short wavelength for the tracking light is to enable configuration of a comparatively inexpensive apparatus, for which it is easy to obtain a position detecting sensor or other light-receiving element with satisfactory wavelength detection.

The free-space optical communication apparatus 100 includes a tracking module 5 (tracking unit) and a transceiving module 3 (separate unit).

The tracking module 5 has an optical antenna portion 1, integrated on the tracking platform 4 and moveably held, and an input/output port portion 2.

The optical antenna portion 1 includes an aperture 1a, enabling incidence of communication light R₁ and tracking light R₂ emitted as substantially coaxial and substantially parallel-ray beams from the other terminal to the communication, with the beam diameters limited; a beam expander 10 (emission/reception light optical system); a beam splitter 11; and a position detector 12 (position detection sensor).

The beam expander 10 is an afocal optical system which reduces the incident beam from the aperture 1a by a prescribed angular magnification, and expands the light emitted from the apparatus interior by a prescribed angular magnification and emits the expanded light. For example, a Kepler-type design employing two groups of positive lenses as shown in the drawing, or a Galileo-type beam expander employing a positive and a negative lens, can be adopted. Alternatively, a Cassegrain-type, Gregorian-type, or other common-axis reflective type beam expander, as well as an eccentric reflective optical system, or a prism optical system having a plurality of eccentric reflective surfaces, can also be adopted.

The beam splitter 11 is an optical element which splits the incident beam, the diameter of which has been reduced by the beam expander 10 according to the wavelength and direction of polarization. In this embodiment, as the beam splitter 11, a polarization dichroic beam splitter, which transmits light of wavelength λ₁, and reflects a polarized component of light of wavelength λ₂, such as for example the polarization component with polarization direction in the direction perpendicular to the plane of the paper in FIG. 1, is used. Consequently the component of the tracking light R₂ with polarization direction perpendicular to the plane of the paper is divided.

The position detector 12 is a sensor to detect the beam center position of the tracking light R₂ divided by the beam splitter 11. The detection output from the position detector 12 is for example output as a shift in position from the received position when for example tracking light R₂ is incident along the optical axis of the optical antenna portion 1.

Any sensor capable of detecting the shift from the reference position of the beam received position may be used as the position detector 12. In this embodiment, a two-dimensional CCD is adopted; but a position detector (PSD), four-segment PD, or similar may be used.

In order that a shorter optical path length corresponds to the position detection range, for example, a condensing lens or other appropriate optical system may be provided between the beam splitter 11 and the position detector 12.

The input/output port portion 2 causes the communication light T, transmitted from transceiver module 3 and the tracking light T₂ from a laser diode (LD) 23 provided within the input/output port portion 2 to be aligned on the same axis and made incident on the optical antenna portion 1.

The input/output port portion 2 includes the LD 23 (light source for tracking), an optical path synthesizer 21, and a connector 51; each of these is fixed within its housing.

The LD 23 is directed along the optical axis of the optical antenna portion 1, emits tracking light T₂ at wavelength λ₂, and is lit as necessary by a driver, not shown. The LD 23 is substantially linearly polarized, with the polarization direction in a direction parallel to the plane of the paper in FIG. 1. On the optical axis of the LD 23 is positioned a collimating lens 22, which shapes light emitted from the LD 23 into a substantially parallel beam shaped into a prescribed beam diameter.

The connector 51 connects the optical fiber 25 connected to the transceiver module 3. Consequently the communication light T₁ transmitted within the optical fiber 25 is incident within the input/output port portion 2. Communication light T₁ emitted from the connector 51 is formed into a substantially parallel beam by the coupling lens 24, and proceeds in a direction intersecting the optical axis of the optical antenna portion 1.

The optical path synthesizer 21 is an optical element which synthesizes the tracking light T₂ and communication light T₁ on the same axis, and causes the light to be incident on the optical antenna portion 1, and is positioned between the collimating lens 22 and the optical antenna portion 1.

As such an optical path synthesizer 21, for example, a dichroic beam splitter, having a light-splitting face which transmits substantially all of the light at wavelength λ₂ and reflects substantially all of the light at wavelength λ₁, can be adopted. The light-splitting face is positioned such that substantially parallel rays emitted from the coupling lens 24 are reflected in substantially the same axis direction as the substantially parallel rays emitted from the collimating lens 22.

The tracking platform 4 integrally holds the optical antenna portion 1 and input/output port portion 2, and is a mobile mechanism enabling rotational movement of the optical axis of the optical antenna portion 1 in a desired direction. This tracking platform 4 has a movement control portion (not shown) which controls the amount of rotational movement according to the detection output from the position detector 12.

As the tracking platform 4, for example, a mobile mechanism combining a gimbal stage and a two-axis rotating stage can be adopted.

The transceiver module 3 transmits communication light T₁ to the tracking module 5, and receives communication light R₁ transmitted from the tracking module 5.

This transceiver module 3 includes a signal receiving portion 29 (communication light detection portion), an EDFA 28 (fiber amp), a circulator 26, an LD 27 (light source for communication), and a connector 52, and is placed in an appropriate housing provided separately from the tracking module 5. These portions are separate from the tracking module 5, and may be placed in a plurality of housings, but in this embodiment are placed in a single unit.

The signal receiving portion 29 includes a photodetector which receives communication light R₁ and obtains a light detection output, and a signal analyzer which performs photoelectric conversion of the light detection output to obtain information signals.

The photodetector can be selected appropriately according to the wavelength of the communication light R₁; for example, at a wavelength of 1550 nm, an InGaAs photodetector, with satisfactory sensitivity and excellent high-speed response in this wavelength range, can be used.

As the EDFA 28, which is one type of optical amplifier, an erbium-doped fiber amplifier, which is most commonly used in the 1550 nm wavelength band among fiber amps using induced emission, is employed. This EDFA 28 has an erbium-doped fiber (hereafter “EDF”) 28a and a pump LD 28b.

The pump LD 28b is a pump light source to inject excitation light (pumping light) at a prescribed wavelength in order to amplify the communication light R₁ transmitted within the EDF 28a. For example, when as in this embodiment λ₁=1550 nm, a pumping light wavelength of 980 nm is appropriate.

The circulator 26 is an optical circuit element having ports p₁, p₂, p₃, which can each be connected to optical fibers; light injected into port p₁ is transmitted to port p₂, and light injected into port p₂ is transmitted to port p₃. This circulator 26 is configured employing an optical device which uses the Faraday effect or similar.

The laser diode (LD) 27 emits communication light T₁ at wavelength λ₁. The LD 27 is driven with modulation by a modulating driver (not shown) based on information signals. The communication light T₁ is optically coupled to the end of an optical fiber 38 by a coupling lens (not shown) or other optical element.

The connector 52 optically connects the optical fiber 25 and the transceiving module 3.

The connector 52 is optically connected to port p₂ by the optical fiber 35, port p₃ is optically connected to the EDFA 28 by the optical fiber 26, and the EDFA 28 is optically connected to the signal receiving portion 29 by the optical fiber 37, to form a transmission path for communication light R₁. The optical fiber 38 and port p₁ are optically connected to form a transmission path for communication light T₁.

Thus the transceiving module 3 is kept separate from the moveable portion of the tracking platform 4, and the interior consists mainly of an optical fiber optical system, in which an optical transmission path is formed by optical fibers, optical circuit elements and similar.

As a result, the transceiving module 3 can be configured making effective use of optical circuit elements widely used in wire optical communications, without being constrained by the masses or sizes of individual components. There is the further advantage that positioning of individual components is simple.

The circulator 26 is used to branch the communication light R₁ and communication light T₁ according to propagation direction, so that the optical fiber 25 and optical fiber 35 can be used as a common optical transmission path for the communication light R₁ and communication light T₁. Consequently the number of optical transmission paths can be reduced, and the configuration can be simplified.

Next, the operation of the free-space optical communication apparatus 100 will be explained.

As shown in FIG. 1, communication light T₁ of wavelength λ₁, emitted from the LD 27, is coupled with the optical fiber 38, transmitted to the port p₁, and transmitted to the optical fiber 35 from port p₂ of the circulator 26. Next, the communication light T₁ passes through the connector 52 and is transmitted into the optical fiber 25, passes through the connector 51, and is emitted into the input/output port portion 2.

Next, the communication light T₁ is rendered into a substantially parallel beam by the coupling lens 24, and is injected into the optical path synthesizer 21 from a direction intersecting the optical path of the optical antenna portion 1. Because the communication light T₁ is a substantially parallel beam with wavelength λ₁, substantially all of the beam is reflected by the optical path synthesizer 21, and proceeds within the optical antenna portion 1 along the optical path direction of the optical antenna portion 1.

Next, the communication light T₁ is effectively all transmitted by the beam splitter 11, is rendered into a substantially parallel beam with expanded diameter by the beam expander 10, and is emitted to outside the apparatus from the aperture 1a.

Communication light R₁ at wavelength λ₁ and communication light R₁ at wavelength λ₂, emitted from the other terminal to the communication, are rendered into substantially parallel beams with beam diameter regulated by the aperture 1a, and are incident on the beam expander 10. Thereafter the communication light R₁ at wavelength λ₁ and at wavelength λ₂ is reduced in diameter by a prescribed angular magnification by the beam expander 10, and is made incident on the beam splitter 11.

The beam splitter 11 reflects substantially all of the component of the light at wavelength λ₂ which is polarized in the direction perpendicular to the plane of the paper, so that of the tracking light R₂, the component polarized in the direction perpendicular to the plane of the paper is substantially all reflected, and is received by the position detector 12.

The position detector 12 detects the beam center position of the received tracking light R₂, and outputs the shift in position from the optical axis of the optical antenna portion 1 to the tracking platform 4. The amount of rotational movement such that the optical axis direction of the optical antenna portion 1 coincides with the optical axis of the tracking light R₂ is computed by the movement control portion (not shown) of the tracking platform 4, and the tracking platform 4 is caused to undergo rotational movement.

On the other hand, the communication light R₁ is light at wavelength λ₁, and so is substantially all transmitted by the beam splitter 11, and is incident on the optical path synthesizer 21. This communication light R₁ is substantially all reflected by the optical path synthesizer 21, and is coupled to the end of the optical fiber 25 in the connector 51 by the coupling lens 24.

Consequently the communication light R₁ is transmitted within the optical fiber 25, passes through the connector 52 and is transmitted to the transceiver module 3.

The communication light R₁ is transmitted from the connector 52 to port p₂ by the optical fibe 35. Thereafter the light is transmitted to port p₃, passes through optical fiber 36, and is transmitted to EDFA 28.

In the EDFA 28, the pump LD 28b causes excitation, and induced emission results in amplification of the communication light R₁, which is transmitted through the optical fiber 37.

The EDFA 28 enables a gain of approximately 10 dB, so that communication is possible over long distances on the ground, for example. When the optical intensity of the communication light R₁ is extremely weak due to atmospheric fluctuations, atmospheric absorption, beam broadening and other effects, the EDFA 28 can easily amplify the optical intensity.

Thus amplified, the communication light R₁ is received by the signal receiving portion 29, and is subjected to photoelectric conversion by the photodetector. The converted electrical signal is subjected to processing by a signal analyzer to extract the appropriate information signal.

By using a fiber amp, amplification can be performed prior to photoelectric conversion, so that the signal can be demodulated efficiently, and there is the added advantage that the transceiving module 3 including the optical fiber optical system can be simplified.

When the optical intensity of the communication light R₁ is adequate, the EDFA 28 may be omitted, with the communication light R₁ transmitted from the port p₃ to the signal receiving portion 29.

Next, the optical path of the tracking light T₂ will be explained.

Tracking light T₂ of wavelength λ₂, emitted from the LD 23, is rendered into a substantially parallel beam by the collimating lens 22, propagates along the optical axis of the optical antenna portion 1, is incident on the optical path synthesizer 21, is transmitted substantially entirely, and is incident on the optical antenna portion 1.

Then, the tracking light T₂ is incident on the beam splitter 11; because the polarization direction is parallel to the plane of the paper, substantially all of the light is transmitted by the beam splitter 11. Then, the beam is widened by a prescribed angular magnification by the beam expander 10, and after passing through the aperture 1a is emitted along the same axis as the communication light T₁.

By means of such a free-space optical communication apparatus 100 of this embodiment, the communication light T₁ and R₁ and the tracking light T₂ from the optical antenna portion 1, with different wavelengths but on the same axis, can be emitted and received, and the tracking light R₂ can be used to track the other terminal to the communication.

At this time, the transceiver module 3, including the light source for communication and the communication light detection portion, is provided separately from the moveable portion of the tracking platform 4, and an optical fiber 25 connects the input/output port portion 2 with the transceiver module 3. Hence the moveable portion of the tracking platform 4 can be made lightweight and compact. As a result, the inertia of the moveable portion of the tracking platform 4 can be reduced, and high-speed tracking operation becomes possible. Thus a free-space optical communication apparatus of this embodiment is suitable for use in communication between mobile bodies.

### Second Embodiment

Next, the free-space optical communication apparatus of a second embodiment of the invention will be explained.

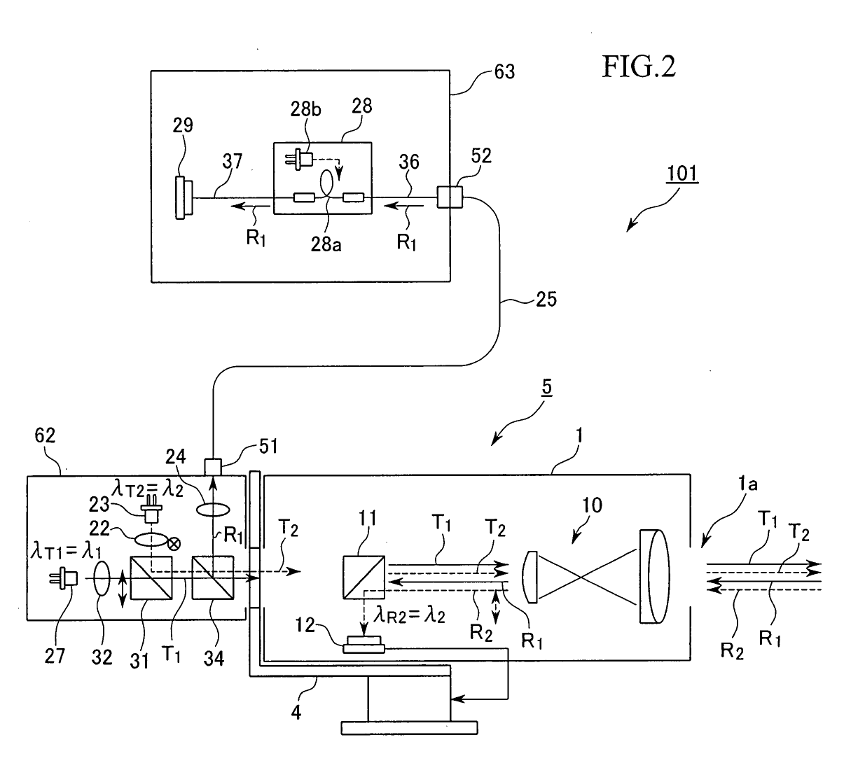

FIG. 2 is a block diagram used to explain in summary the configuration of a free-space optical communication apparatus of the second embodiment of the invention.

As shown in FIG. 2, the free-space optical communication apparatus 101 of this embodiment uses communication light T₁ and R₁ and tracking light T₂ and R₂, at wavelengths similar to those in the first embodiment, to perform bidirectional free-space optical communication. This free-space optical communication apparatus 101 has, in place of the input/output port portion 2 and transceiver module 3 of the first embodiment, an input/output port portion 62 and receiving module 63 (separate unit).

The input/output port portion 62 has, in place of the input/output port portion 2, an LD 27, collimating lens 32, optical path synthesizer 41, and optical path branch 34.

The receiving module 63 is equivalent to the transceiving module 3 with the LD 27, circulator 26, and optical fibers 35 and 38 removed.

The following explanation focuses mainly on differences with the first embodiment.

The free-space optical communication apparatus 101 is provided with a light source for communication in the input/output port portion 62 which together with the optical antenna portion 1 constitutes the tracking unit.

The optical path synthesizer 31 is an optical element to synthesize on the same axis the tracking light T₂, consisting of the substantially parallel beam at wavelength λ₂ formed by the LD 23 and collimating lens 22, and the communication light T₁ at wavelength λ₁, formed into a substantially parallel beam by the collimating lens 32 from the light emitted from the LD 27.

In this embodiment, a dichroic beam splitter having a light-branching face which for example transmits substantially all light at λ₁=1550 nm and reflects substantially all light at λ₂=780 nm, can be employed as the optical path synthesizer 31.

The LD 27 is positioned such that the communication light T₁ propagates in a direction along the optical axis of the optical antenna portion 1, with the polarization direction in the direction perpendicular to the plane of the paper in FIG. 2.

The LD 23 is positioned such that the polarization direction of the tracking light T₂ is in a direction parallel to the plane of the paper in FIG. 2.

The optical path branch 34 is an optical element to split the communication light R₁ and communication light T₁, and is positioned on the optical axis of the optical element portion 1 between the optical path synthesizer 31 and the optical antenna portion 1.

In this embodiment, because the wavelength of the communication light R₁ and the communication light T₁ is common at λ₁=1550 nm, a polarizing dichroic beam splitter, having a light splitting face which transmits substantially all of light at λ₂=780 nm as well as the component of light at λ₁=1550 nm with polarization in a direction parallel to the plane of the paper in FIG. 2, and which reflects substantially all of the component of light at λ₁=1550 nm with polarization perpendicular to the plane of the paper in FIG. 2, can be used as the optical path branch 34.

The optical path branch 34 performs functions similar to those of the circulator 26 in the first embodiment.

By means of such a configuration, the communication light T₁ emitted from the LD 27 is rendered into a substantially parallel beam by the collimating lens 32, propagates along the optical axis of the optical antenna portion 1, passes through the optical path synthesizer 31 and optical path branch 34, is incident on the optical antenna portion 1, undergoes beam diameter expansion, and is emitted from the aperture 1a.

Further, the tracking light T₂ emitted from the LD 23 is rendered into a substantially parallel beam by the collimating lens 22, is reflected by the optical path synthesizer 31 and propagates in a direction along the optical axis of the optical antenna portion 1, passes through the optical path branch 34, undergoes beam diameter expansion, and is emitted from the aperture 1a.

The component of the communication light R₁ received by the optical antenna portion 1 which is polarized in the direction perpendicular to the plane of the paper in FIG. 2 is reflected by the branching face of the optical path branch 34, and is coupled with the optical fiber 25 in the connector 51 by the coupling lens 24. Thereafter, the communication light R₁ is transmitted within the optical fiber 25, is transmitted from the connector 52 to the optical fiber 36 within the receiving module 63, and after being amplified by the EDFA 28 is received by the signal receiving portion 29.

The tracking light R₂ propagates along an optical path similar to that in the first embodiment, and so an explanation is omitted.

According to the free-space optical communication apparatus of this embodiment, the light source for communication and light source for tracking are consolidated in the tracking unit, in a configuration in which the communication light detection portion is provided in the separate unit, enabling bidirectional free-space optical communication.

Compared with the first embodiment, although the amount of weight reduction is reduced by incorporation of a light source for communication, the weight is reduced by providing the communication light detection portion, fiber amp and other components separately.

Moreover, the LDs 27 and 23 are provided in proximity to the optical path synthesizer 31, so that the light source for communication and the light source for tracking can be positioned compactly.

As a result, the LDs 27 and 23 can for example be positioned on a common driving board, and so there is the advantage that the number of components of the transmission system can be reduced, and the physical size can be decreased.

### Third Embodiment

Next, the free-space optical communication apparatus of a third embodiment of the invention will be explained.

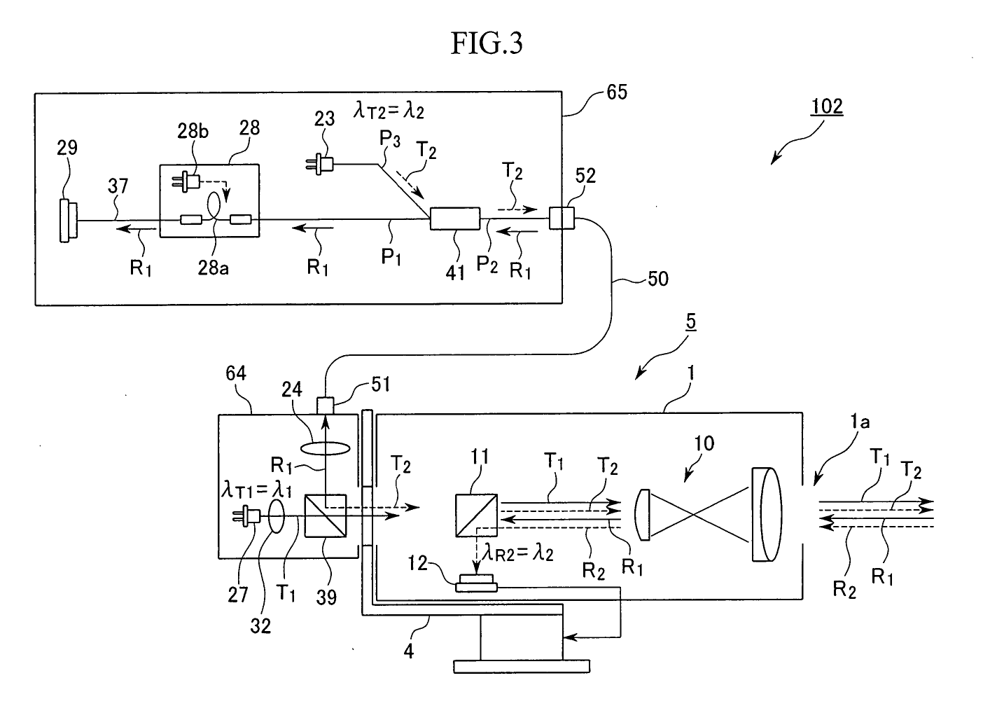

FIG. 3 is a block diagram used to explain in summary the configuration of the free-space optical communication apparatus of the third embodiment of the invention.

As indicated in FIG. 3, the free-space optical communication apparatus 102 of this embodiment uses communication light T₁, R₁ and tracking light T₂, R₂ with wavelengths similar to those of the first embodiment, to perform bidirectional free-space optical communication. In this free-space optical communication apparatus 102, in place of the input/output port portion 2, transceiver module 3 and optical fiber 25 of the first embodiment, an input/output port portion 64, receiving module 65 (separate unit), and polarization-preserving optical fiber 50 are provided.

The input/output port portion 64 has, in place of the optical path synthesizer 21, an LD 23 and a collimating lens 22 of the input/output port portion 2, an optical path branch 39, LD 27, and collimating lens 32.

The receiving module 65 has, in place of the LD 27 and circulator 26 of the transceiving module 3, an LD 23 and wavelength separating coupler 41.

The following explanation focuses mainly on differences with the first embodiment.

The free-space optical communication apparatus 102 is provided with a light source for communication in the input/output port portion 64 which together with the optical antenna portion 1 forms the tracking unit, and a light source for tracking and communication photodetector are provided in the receiving module 65 which is a separate unit.

In the input/output port portion 64, the LD 27 and collimating lens 32 are positioned such that communication light T₁ rendered into a substantially parallel beam is emitted in the direction along the optical axis of the optical antenna portion 1, with the polarization direction in a direction parallel to the plane of the paper in FIG. 3.

The optical path branch 39 is an optical element which splits the communication light R₁ and communication light T₁, and also synthesizes, in a common-axis optical path, the tracking light T₂ and communication light T₁, and is positioned on the optical axis of the optical antenna 1 between the collimating lens 32 and the optical antenna portion 1.

In this embodiment, the communication light R₁ and communication light T₁ have a common wavelength of λ₁=1550 nm, so that as the optical path branch/synthesizer 39, a polarizing dichroic beam splitter can be adopted having an optical branching face which for example transmits substantially all of the component of light at λ₁=1550 nm polarized in a direction parallel to the plane of the paper in FIG. 3, and reflects substantially all of the component of light at λ₁=1550 nm polarized in the direction perpendicular to the plane of the paper in FIG. 3.

The wavelength separating coupler 41 has an input port P₂ and output ports P₁ and P₃, and as shown in FIG. 3, the input port P₂ is connected to the connector 53, the output port P₁ is connected to the EDFA 28, and the output port P₃ is connected to the LD 23.

In order that light of wavelengths λ₂ and λ₁ does not intrude in the EDFA 28 and LD 23 respectively to cause noise, the coupler 41 has wavelength-separating characteristics such that light input to the input port P₂ is transmitted to the output ports P₁ or P₃ according to the wavelength. Further, the coupler is configured such that at least light of wavelength λ₂ is transmitted with the polarization direction preserved in the input port P₂ and output port P₃.

Here, the LD 23 and output port P₃ are for example optically coupled by a coupling lens or other coupling means, not shown.

The polarization-preserving optical fiber 50 is an optical fiber which preserves the polarization direction for, at least, light at wavelength λ₂.

By means of such a configuration, communication light T₁ emitted from the LD 27 is rendered into a substantially parallel beam by the collimating lens 32, propagates along the optical axis of the optical antenna portion 1, passes through the optical path branch/synthesizer 39, is incident upon the optical antenna portion 1, undergoes diameter expansion, and is emitted from the aperture 1a.

Tracking light T₂ emitted from the LD 23 is coupled with the output port P₃ of the wavelength separating coupler 41 by coupling means, not shown, and is transmitted, with polarization direction preserved, to the input port P₂. Thereafter the tracking light T₂ passes through the connector 52, is transmitted into the polarization-preserving fiber 50, and is emitted with the polarization direction perpendicular to the plane of the paper in FIG. 3. Next, the tracking light T₂ is rendered into a substantially parallel beam by the coupling lens 24, and is injected into the optical path branch/synthesizer 39 from a direction intersecting the optical axis of the optical antenna portion 1. The tracking light T₂ is then reflected by the branching face of the optical path branch/synthesizer 39, propagates along the optical axis of the optical antenna portion 1, is incident on the optical antenna portion 1, undergoes diameter expansion, and is emitted from the aperture 1a.

The component of communication light R₁ received by the optical antenna portion 1 with polarization perpendicular to the plane of the paper in FIG. 3 is reflected by the branching face of the optical path branch/synthesizer 39, and is coupled by the coupling lens 24 with the polarization-preserving optical fiber 50 at the connector 51. Next, the communication light R₁ is transmitted within the polarization-preserving optical fiber 50, and from the connector 52 is transmitted to the input port P₂ of the wavelength-separating coupler 41. Due to the wavelength separating characteristics of the wavelength-separating coupler 41, substantially all of the communication light R₁ is then transmitted into the output port P₁. Thereafter the communication light R₁ is amplified by the EDFA 28, and then received by the signal receiving portion 29.

The tracking light R₂ propagates over an optical path similar to that in the first embodiment, and so an explanation is omitted.

According to the free-space optical communication apparatus of this embodiment, the light source for communication is integrated into the tracking unit, and the light source for tracking and communication light detection portion are provided in the separate unit, enabling bidirectional free-space optical communication.

In this case, although a light source for communication has been incorporated into the tracking unit, the weight is reduced by separately providing the light source for tracking, communication light detection portion, fiber amp and other components.

In this configuration, two wavelengths coexist in the receiving module 65, and so in general a configuration employing a circulator cannot be used, and a technically more advanced two-wavelength circulator or other means must be employed; but by adopting a wavelength-separating coupler 41 in this embodiment, an equivalent configuration can be realized easily and inexpensively.

### Fourth Embodiment

Next, the free-space optical communication apparatus of a fourth embodiment of the invention will be explained.

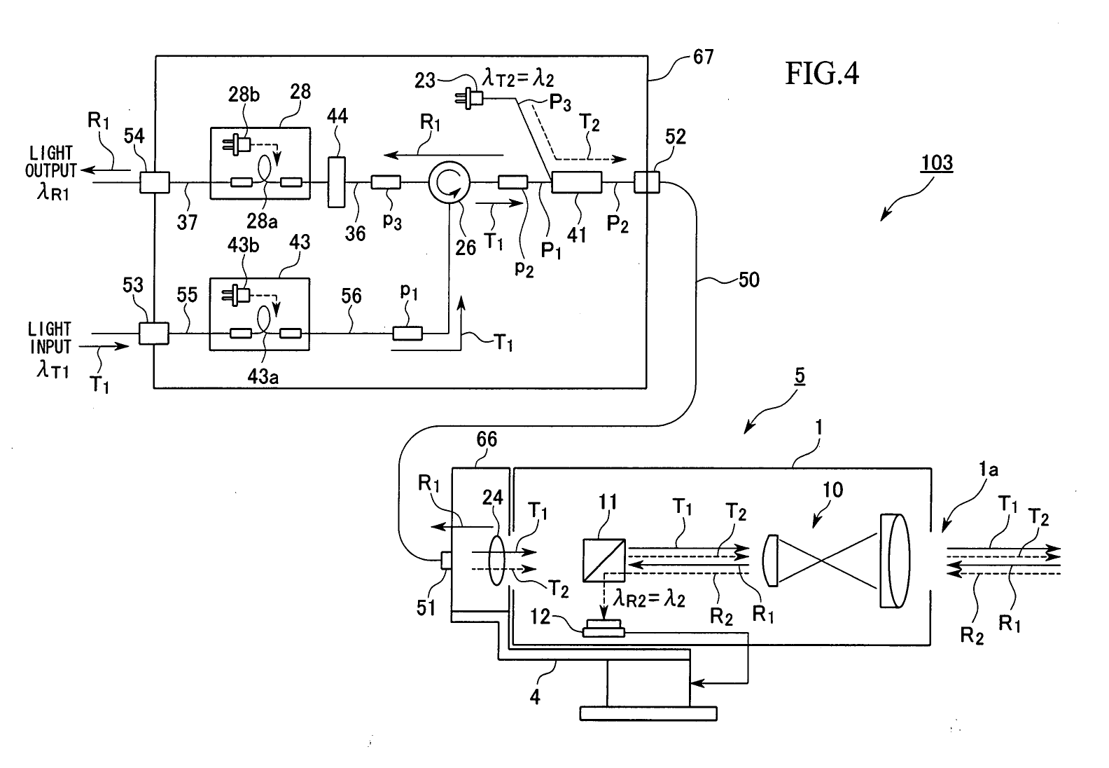

FIG. 4 is a block diagram used to explain in summary the configuration of the free-space optical communication apparatus of the fourth embodiment of the invention.

As shown in FIG. 4, the free-space optical communication apparatus of this embodiment differs from the first embodiment in that, of the wavelengths λ_{T1}, λ_{R1}, λ_{T2}, λ_{R2} of the communication light T₁ and R₁ and of the tracking light T₂ and R₂, when only λ_{T2} and λ_{R2} are equal, bidirectional free-space optical communication is performed.

By thus changing the wavelengths of the communication light T₁ and λ₁, there is the advantage that returning light, leakage light, and other noise in the optical system can easily be isolated. At this time, if the wavelength difference is kept comparatively small, there is almost no change in the reflectivity or transmissivity, and so there are the advantages that the optical elements, optical circuit elements and similar in the optical system can be used in common, and that coatings of such elements can be made simple. For example, it is preferable that the wavelengths of the communication light T₁ and R₁ be within the range of the following conditional expression.
0 nm<|λ_{T1}−λ_{R1}|<50 nm (3)

Here the upper limit is set in order that changes in the reflectivity and transmissivity are not too great for the same coating.

In this embodiment, λ_{T1}=1550 nm and λ_{R1}=1560 nm. Also, λ_{T2}=λ_{R2}=λ₂=980 nm.

The wavelengths of the tracking light T₂ and R₂ may also be made different as necessary. In this case, if the wavelength difference is set within the range of the following conditional expression, advantageous results for the action of the apparatus similar to those for the case of communication light are obtained.
0 nm<|λ_{T2}−λ_{R2}|<50 nm (4)

The free-space optical communication apparatus 103 has, in place of the input/output port portion 2, transceiver module 3, and optical fiber 25 of the first embodiment, an input/output port portion 66, transceiver module 67 (separate unit), and polarization-preserving optical fiber 50.

The input/output port portion 66 is equivalent to the input/output port portion 2 with the LD 23 and collimating lens 22 removed. The input/output port portion 66 uses the coupling lens 24 to couple the communication light R₁, injected through the optical antenna portion 1, to the end face of the polarization-preserving optical fiber 50 by the connector 51. The input/output port portion 66 also renders the communication light T₁ and tracking light T₂ emitted from the polarization-preserving optical fiber 50 into substantially parallel beams, and emits these along the optical axis of the optical antenna portion 1. The polarization-preserving optical fiber 50 is positioned using the connector 51 such that the polarization direction of the tracking light T₂ is in a direction parallel to the plane of the paper in FIG. 4.

The transceiving module 67, in place of the signal receiving portion 29 and LD 27 of the transceiving module 3, has a received light output portion 54 (communication light detection portion) and emitted light input portion 53 (light source for communication), and additionally has an LD 23, wavelength-separating coupler 41, EDFA 43 (fiber amp), and band-pass filter 44.

Below, differences with the first embodiment will be mainly explained.

In the free-space optical communication apparatus 103, a light source for communication, communication light detection portion, light source for tracking, and fiber amp are provided in the transceiver module 67 which is a separate unit, and the configuration of the tracking unit is the smallest possible configuration which includes the light emission/reception light optical system and direction shift detector. The light source for communication and communication light detection portion are provided as a light input/output portion of the end of an optical fiber.

The emission light input portion 53 guides the communication light TI, transmitted within an optical fiber outside the transceiver module 67, into the optical fiber 55 using an optical connector, to transmit the light into the transceiver module 67.

The EDFA 43 is connected to the optical fiber 55, and is provided with an EDF 43a and pump LD 43b in order to amplify the communication light T₁ input from the emission light input portion 53. The wavelength of the pump LD 43b is, similarly to the pump LD 28b, set according to the wavelength λ_{T1}. The output side of the EDFA 43 is connected to port p₁ of the LD 23 via the optical fiber 56.

In this embodiment, an EDFA 43 is provided as appropriate to a case in which the optical intensity of the communication light T₁ transmitted in the external optical fiber is attenuated. But when the communication light T₁ is transmitted with sufficient optical intensity, the EDFA 43 may be omitted.

The received light output portion 54 is connected to an optical fiber 37 by an optical connector in order to transmit the communication light R₁ to the optical fiber of the transceiver module 67.

In order to prevent transmission of light at wavelengths other than λ_{R1} to the EDFA 28, a band-pass filter 44 having a bandwidth at least sufficient to enable removal of light at wavelength λ_{T1} is provided midway in the optical fiber 36 connecting the EDFA 28 and the LD 23.

In the wavelength-separating coupler 41, the output port P₁ is connected to port p₂ of the circulator 26, the output port P₃ is connected to the LD 23, and the input port P₂ is connected to the connector 52. Light at wavelength λ_{R1} is transmitted on the transmission path from input port P₂ to output port P₁.

The polarization-preserving optical fiber 50 is positioned between the connectors 52 and 51 such that the tracking light T₂, emitted by the LD 23 and transmitted from the output port P₃ of the wavelength-separating coupler 41 toward the input port P₂ with polarization direction preserved, has polarization direction in a direction parallel to the plane of the paper in FIG. 4 at the connector 51.

By means of this configuration, communication light T₁ emitted from the emission light input portion 53 is transmitted through the optical fiber 55 and amplified by the EDFA 43. Then, the communication light T₁ is transmitted from port p₁ to port p₂ of the circulator 26, passes through the output port P₁ and input port P₂ of the wavelength-separating coupler 41, and is transmitted from the connector 52 to the polarization-preserving optical fiber 50.

Thereafter, the communication light T₁ is emitted from the connector 51, rendered into a substantially parallel beam by the coupling lens 24, is incident on the optical antenna portion 1, undergoes diameter expansion, and is emitted from the aperture 1a.

Tracking light T₂ emitted from the LD 23 is coupled with the output port P₃ of the wavelength-separating coupler 41 by coupling means, not shown, and is transmitted, with the polarization direction preserved, to the input port P₂. Then, the tracking light T₂ passes through the connector 52, is transmitted within the polarization-preserving fiber 50, and is emitted with the polarization direction perpendicular to the plane of the paper in FIG. 3. Thereafter the tracking light T₂ is rendered into a substantially parallel beam by the coupling lens 24, is incident on the optical antenna portion 1, passes through the optical branch device 11, is incident on the beam expander 10, undergoes diameter expansion, and is emitted from the aperture 1a.

The communication light R₁ received by the optical antenna 1 passes through the optical branch device 11, and is coupled with the polarization-preserving optical fiber 50 at the connector 51 by the coupling lens 24. Then, the communication light R₁ is transmitted within the polarization-preserving fiber 50, and is transmitted from the connector 52 to the input port P₂ of the wavelength-separating coupler 41. Thereafter substantially all of the communication light R₁ is transmitted within the output port P₁ due to the wavelength-separating characteristics of the wavelength-separating coupler 41. The communication light R₁ is then transmitted from port p₁ to port p₃ of the circulator 26, and substantially only light at wavelength λ_{R1} is incident on the EDFA 28 due to the band-pass filter 44, is amplified, passes through the optical filter 37 and is coupled with the received light output portion 54, and is transmitted toward the external optical fiber. Within the external optical fiber, the communication light R₁ is transmitted to an appropriate receiving portion connected to the optical fiber, at which information signals are extracted.

The tracking light R₂ propagates along an optical path similar to that in the first embodiment, and so an explanation is omitted.

According to the free-space optical communication apparatus of this invention, the tracking unit can consist substantially of only the optical antenna portion, with the light source for communication, light source for tracking, communication light detection portion, and fiber amp placed in a separate unit, so that the tracking unit can be made dramatically lighter. By this means, the inertia of the moveable portion of the tracking platform can be reduced, so that high-speed tracking operation becomes possible.

In the transceiver module 67, three wavelengths coexist; in this embodiment, the tracking light T₂, with a comparatively large wavelength difference, and the communication light Tt₁ and communication light R₁, are separated using a comparatively inexpensive wavelength-separating coupler 41. A circulator 26 is used only for separation of the communication light T₁ and communication light R₁, the wavelength difference of which is set to be extremely small. By means of this configuration, a free-space optical communication apparatus can be realized at low cost.

In the explanations of the above first through fourth embodiments, examples were explained in which the tracking light R₂ is detected by a position detector 12, and by moving the tracking platform 4 tracking operation is performed; this tracking operation can be coarse tracking, with a more precise fine tracking operation also enabled.

As an example of this configuration, a case is briefly explained in which a polarizing reflective optical system is used as the beam expander 10. For convenience, a case is explained of application to the first embodiment, but upon making necessary and appropriate corrections according to the wavelength of the tracking light, the polarization state and other conditions, application to other embodiments is extremely easy.

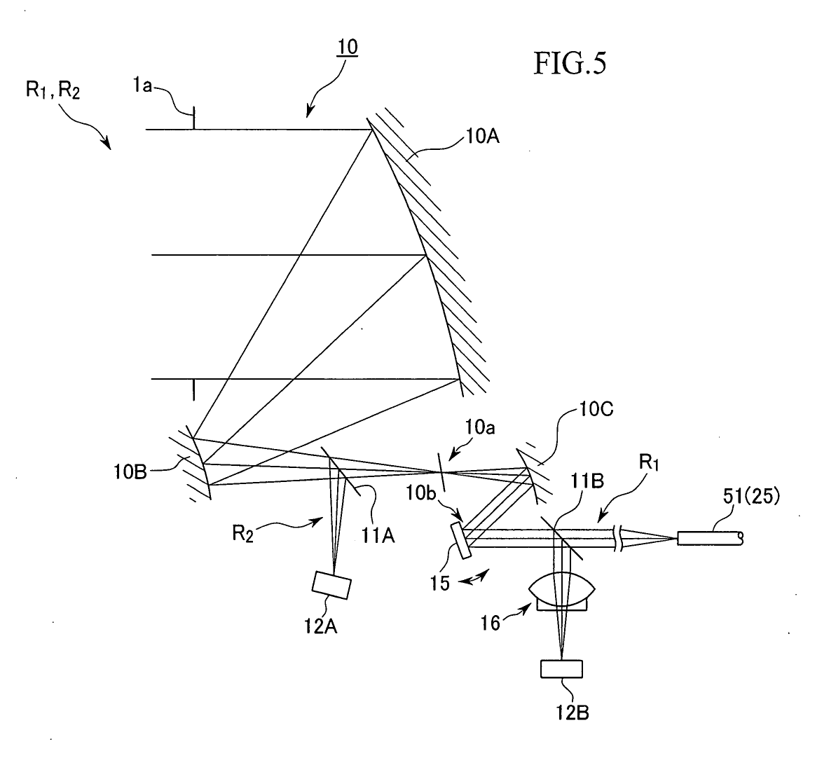

FIG. 5 is an optical path diagram, in a cross-section containing the optical axis, to explain the configuration of a modified example of the first through fourth embodiments.

As shown in FIG. 5, in this modified example the beam expander 10 includes reflecting mirrors 10A, 10B, and 10C; in place of the optical branch device 11, optical branch devices 11A and 11B are provided; in place of the position detector 12, position detectors 12A and 12B are provided; and, a galvano-mirror 15, which is a light deflector, is provided. The configuration of these components is explained below, moving along the optical paths of the communication light R₁ and tracking light R₂.

The beam expander 10 of this modified example is positioned along the optical axis with reflecting mirrors in the order 10A, 10B, and 10C; an intermediate image 10a is formed in the optical path, and an afocal optical system is formed in which the substantially parallel beams which are the communication light R₁ and tracking light R₂ are emitted. An emission pupil 10b is formed near the reflecting mirror 10C.

The reflecting mirrors 10A, 10B, and 10C are for example reflecting surfaces having positive, negative and positive powers respectively, with reflecting surfaces positioned eccentrically or at an inclination to the optical axis of the input light, to form a zigzag folding optical path. The intermediate image 10a is for example formed at the midpoint between the reflecting mirror 10B and the reflecting mirror 10C, and an optical branch device 11A is positioned in the optical path between the reflecting mirror 10B and the intermediate image 10a.

The surface shapes of the optically active surfaces of the reflecting mirrors 10A, 10B, and 10C are free curved surfaces, including asymmetric surfaces of revolution appropriate for correction of decentering aberration.

The optical branch device 11A has an optical branching face set so as to reflect a portion, such as for example 30%, of the component of light at wavelength λ_{R2} polarized in the direction perpendicular to the plane of the paper. Light reflected by the optical branch device 11A is guided to a position detector 12A, consisting for example of a CCD, and configured similarly to the position detector 12.

The galvano-mirror 15, positioned close to the emission pupil 10b, is a moveable mirror to control the direction of propagation of the substantially parallel beam emitted from the reflecting mirror 10C. The galvano-mirror 15 rotates according to control signals from rotation control means, not shown, and the angle of the reflecting surface is controlled.

The optical branch device 11B is positioned in the optical path between the galvano-mirror 15 and the connector 51, and has an optical branching face which reflects substantially all of the component of light at wavelength λ_{R2} polarized in the direction perpendicular to the plane of the paper; the reflected light is guided to a position detector 12B, consisting of a four-segment PD or similar suited for high-precision position detection.

The lens 16 is an optical element provided as necessary to focus light reflected by the optical branch device 11B so as to obtain the appropriate beam diameter and movement amount on the position detector 12B.

Although not shown in the drawing, similarly to the first embodiment, an optical path synthesizer 21 and coupling lens 24 are positioned between the optical branch device 11B and connector 51. When modifying a different embodiment, optical components such as a coupling lens 24, optical path branch 34, optical path branch/synthesizer 39, and similar are positioned as necessary.

The reflecting mirrors 10A, 10B, 10C can also be configured as decentered reflecting prisms, with the optically active surfaces realized by internal reflection. In addition to the reflecting faces, a decentered reflecting prism can be used which incorporates the optical branching face of the optical branch device 11A.

A brief explanation of operation of the modified example is given, with emphasis on coarse tracking and fine tracking operation.

The communication light R₁ at wavelength λ₁ and tracking light R₂ at wavelength λ₂, emitted by the other terminal to the communication, are incident on the beam expander 10, as substantially parallel beams with the same axis and with beam diameters regulated by the aperture 1a. The communication light R₁ and tracking light R₂ are focused by the reflecting mirrors 10A and 10B.

Of the tracking light R₂ incident on the optical branch device 11A, 30% of the component with polarization in the direction perpendicular to the plane of the paper is reflected due to the action of the branching face of the optical branch device 11A, and is received by the position detector 12A.

The position detector 12A detects the beam center position of the received tracking light R₂ and outputs the amount of position shift from the optical axis of the optical antenna portion 1 to the tracking platform 4. The amount of rotation movement such that the optical axis direction of the optical antenna portion 1 coincides with the optical axis of the tracking light R₂ is computed by the movement control portion (not shown) of the tracking platform 4, and rotation movement of the tracking platform 4 is performed (coarse tracking operation).

On the other hand, tracking light R₂ which has passed through the optical branch device 11A is rendered into a substantially parallel beam by the reflecting mirror 10C, is reflected by the galvano-mirror 15, and through the action of the optical branching face of the optical branch device 11B, substantially all of the component of the tracking light R₂ with polarization in the direction perpendicular to the plane of the paper is reflected, and is received by the position detector 12B.

The position detector 12B detects the beam center position of the received tracking light R₂, and outputs the amount of position shift from the optical axis of the optical antenna portion 1 to the galvano-mirror 15. The rotation control portion (not shown) of the galvano-mirror 15 computes the amount of rotation movement such that the optical axis direction of the coupling lens 24 coincides with the optical axis of the tracking light R₂, and rotation movement of the galvano-mirror 15 is performed (fine tracking operation). In this way, information on the shift in direction detected by the position detector 12B is fed back to an optical deflector, so that the communication light R₁ passing through the optical branch device 11B propagates on the optical axis through an optical path synthesizer and coupling lens 24, not shown, and is coupled efficiently with the connector 51.

Such fine tracking operation is performed extremely rapidly by the galvano-mirror 15 with small inertia. And by using a four-segment PD or other high-precision position detector as the position detector 12B, highly precise tracking can be performed.

By providing such a fine tracking mechanism, if fine tracking is first used to perform tracking, and when the shift amount exceeds a fixed amount the movement control portion of the tracking platform 4 and the rotation control portion of the galvano-mirror 15 are linked to perform coarse tracking, shifts in incidence direction, fluctuations and similar can be absorbed substantially in real-time. Consequently the position of incidence of communication light R₁ on the connector 51 can be made stable, and fluctuations in amount of light received due to shifts in the position of incidence of the communication light R₁ can be prevented.

In this modified example, fine tracking is performed such that communication light R₁ is always incident in the range of the optical fiber NA, and the light-receiving face of the connector 51 is the end face of the optical fiber 25. By this means, there is the advantage that a simple configuration can be used to suppress the occurrence of optical losses in the connector 51 and optical noise.

Even if a coarse tracking mechanism alone is provided, if tracking is performed such that the communication light R₁ is incident in the range of the optical fiber NA, then similarly to the above-described first through fourth embodiments, it is preferable that the light-receiving face of the connector 51 be the end face of the optical fiber 25.

In the above explanations, a LD 27 and signal receiving portion 29 are used in the first through third embodiments as the light source for communication and as the communication light detection portion, whereas in the explanation of the fourth embodiment the emitted light input portion 53 and received light output portion 54 were used; but configurations can be modified as appropriate with these reversed. When adopting the emitted light input portion 53 and received light output portion 54, the original light source and the light detector can be provided connected directly to a wire communication network, or can be provided on another wire communication network with relays by a wire communication network such as the former.

In the above explanation, in order to appropriately separate the optical paths of received communication light and tracking light, and of emitted communication light and tracking light, examples were explained in which at least one among the wavelength and the polarization direction is changed. Various other combinations of wavelength types and polarization directions are possible, and the invention is not limited to those described above.

Further, in the above explanations the light source for communication and the light source for tracking are provided separately; but only a light source for communication may be provided. When performing communication using such a combination, a configuration can be employed in which an optical branch device is used to branch received communication light and guide the light to the direction shift detector to be used as tracking light.

Further, in the above explanations examples were explained in which the tracking unit is connected to the separate unit by a single optical fiber. When there are no problems such as space or cost, a plurality of optical fibers can be used for connection. For example, when the separate unit is provided with a light source for communication, a light source for tracking, and a communication light detection portion, one optical fiber can be provided specifically for each of these and connected to the tracking unit. For example, a plurality of polarizing dichroic beam splitters or similar can be combined between the optical antenna portion and each of the optical fibers, providing appropriate optical path synthesizers/branches, to realize such a configuration.

In the case of such a configuration, there is the advantage that the respective beams need not be separated within the separate unit.

In a free-space optical communication apparatus of this invention, it is preferable that at least one of the above light sources consist of a light source for communication which supplies communication light modulated by information signals, and a light source for tracking which supplies tracking light for the other terminal to perform tracking.

In a free-space optical communication apparatus of this invention, it is preferable that the separate unit include the communication light detection portion, and that the tracking platform be caused to undergo tracking movement so as to maximize the coupling efficiency of communication light received by the optical antenna portion with respect to the optical fiber connected to the tracking unit, according to the detection output of the direction shift detector.

In a free-space optical communication apparatus of this invention, it is preferable that the separate unit be configured using an optical fiber optical system for internal optical transmission.

Devices used in an optical fiber optical system include, for example, optical fiber connectors, circulators, couplers, fiber amps, isolators, coupling lenses, collimating lenses, band-pass filters, and similar.

In order to configure such an optical fiber optical system, an optical fiber with light transmitted from outside the apparatus can be used as a light source, and another optical fiber which receives and transmits light outside the apparatus can be used as a communication light detection portion.

In a free-space optical communication apparatus of this invention, it is preferable that an optical fiber connecting the tracking unit be configured so as to transmit light to be emitted and light received.

Light to be emitted and light received can be separated by changing the wavelength or polarization state. When light to be emitted and light received include communication light and tracking light, separation can similarly be accomplished easily by changing the wavelength or polarization state.

When changing the light polarization state and performing the above-described separation, a polarization-preserving fiber is used as the optical fiber.

Among free-space optical communication apparatuses of this invention, it is preferable that in a configuration which includes at least one light source consisting of both a light source for communication and a light source for tracking, the optical antenna portion and the light source for tracking be integrated in the tracking unit, and that the communication light detection portion and light source for communication be provided in the separate unit.

Among free-space optical communication apparatuses of this invention, it is preferable that in a configuration which includes at least one light source consisting of both a light source for communication and a light source for tracking, the optical antenna portion, light source for tracking, and light source for communication be integrated in the tracking unit, and that the communication light detection portion be provided in the separate unit.

Among free-space optical communication apparatuses of this invention, it is preferable that in a configuration which includes at least one light source consisting of both a light source for communication and a light source for tracking, the light source for tracking, light source for communication, and communication light detection portion be integrated in the separate unit.

In a free-space optical communication apparatus of this invention, it is preferable that the emission/reception light optical system include a beam expander which both expands the diameter of the beam of light for emission, and also contracts the diameter of received light, and that the direction shift detector include an optical branch device which splits the tracking light used in tracking the other terminal from the light received with diameter reduced by the beam expander, and a position detection sensor which detects the position of reception of the tracking light split by the optical branch device.

As explained above, according to a free-space optical communication apparatus of this invention, at least one light source and communication light detection portion is removed from the tracking unit as at least one separate unit and is optically connected to the tracking unit by optical fiber, so that there are the advantages the moveable portion of the tracking platform can be made smaller and lighter in weight, inertia can be reduced, and high-speed tracking operation can become possible.

What is claimed is:

1. A free-space optical communication apparatus which performs bidirectional optical communication while tracking the other terminal through free space, comprising:
at least one light source for emission of light outside said apparatus;
an optical antenna portion having an emission/reception light optical system which emits light from said one or more light source and receives light from outside said apparatus, and a direction shift detector which splits tracking light used in tracking said other terminal from light received by said emission/reception optical system to detect direction shift information from said tracking light;
a tracking platform which supports said optical antenna portion in a manner enabling tracking movement according to the detection output of said direction shift detector;
a communication light detection portion which receives the portion of communication light modulated by information signals among the received light;
a separate unit which includes at least one of said at least one light source and said communication light detection portion and is provided separately from a moveable portion of said tracking platform;
a tracking unit which includes said optical antenna portion and is provided integrally with said moveable portion of said tracking platform; and
an optical fiber which connects said separate unit and said tracking unit.

2. The free-space optical communication apparatus according to claim 1, wherein said at least one light source includes a light source for communication, which supplies communication light modulated by information signals, and a light source for tracking, which supplies tracking light for tracking by said other terminal.

3. The free-space optical communication apparatus according to claim 1, wherein said separate unit includes said communication light detection portion, and said tracking platform is driven according to the detection output of said direction shift detector such that the coupling efficiency of communication light received by said optical antenna portion, with respect to the optical fiber connected to said tracking unit, is maximum.

4. The free-space optical communication apparatus according to claim 1, wherein an optical fiber optical system is used for optical transmission within said separate unit.

5. The free-space optical communication apparatus according to claim 1, wherein an optical fiber connected to said tracking unit transmits said light for emission and said received light.

6. The free-space optical communication apparatus according to claim 2, wherein said optical antenna portion and said light source for tracking are integrated with said tracking unit, and said communication light detection portion and said light source for communication are provided in said separate unit.

7. The free-space optical communication apparatus according to claim 2, wherein:
said optical antenna portion, said light source for tracking, and said light source for communication are integrated with said tracking unit; and
said communication light detection portion is provided in said separate unit.

8. The free-space optical communication apparatus according to claim 2, wherein said light source for tracking, said light source for communication, and said communication light detection portion are provided in said separate unit.

9. The free-space optical communication apparatus according to claim 1, wherein:
said emission/reception light optical system includes a beam expander which expands the beam diameter of said light for emission and reduces the beam diameter of said received light; and
said direction shift detector includes an optical branch device which splits tracking light used in tracking by said other terminal from said received light after diameter reduction by said beam expander, and a position detection sensor which detects the reception position of tracking light split by said optical branch device.
